(19) United States
(12) Patent Application Publication
(10) Pub. No.: US 2015/0358981 A1
(43) Pub. Date: Dec. 10, 2015

(54) METHOD AND APPARATUS FOR PERFORMING DEVICE-TO-DEVICE COMMUNICATION IN WIRELESS COMMUNICATION SYSTEM

(71) Applicant: LG ELECTRONICS INC., Yeongdeungpo-gu, Seoul (KR)

(72) Inventors: Hyukjin CHAE, Seoul (KR); Hanbyul SEO, Seoul (KR); Hakseong KIM, Seoul (KR); Inkwon SEO, Seoul (KR)

(73) Assignee: LG ELECTRONICS INC., Yeongdeungpo-gu, Seoul (KR)

(21) Appl. No.: 14/759,391

(22) PCT Filed: Jan. 7, 2014
(86) PCT No.: PCT/KR2014/000146

§ 371 Date: Jul. 6, 2015

Related U.S. Application Data
(60) Provisional application No. 61/749,875, filed on Jan. 7, 2013.

(51) Int. Cl. H04W 72/08; H04W 24/08; H04L 5/00; H04W 76/02

(52) U.S. Cl. CPC H04W 72/085; H04W 76/023; H04W 24/08; H04L 5/0048; H04W 92/18

(57) ABSTRACT

One embodiment of the present invention relates to a method for enabling a first device to perform device-to-device (D2D) communication in a wireless communication system, comprising the steps of: receiving a D2D candidate list from a third device; receiving a D2D reference signal transmitted from a second device included in the D2D candidate list; and performing measurement using the D2D reference signal; and transmitting the measured result to the third device.

### TECHNICAL FIELD

Following description relates to a wireless communication system, and more particularly, to a method of performing measurement and communication related to the measurement in a D2D (device-to-device) communication.

### BACKGROUND ART

Wireless communication systems are widely deployed to provide various kinds of communication content such as voice and data. Generally, these communication systems are multiple access systems capable of supporting communication with multiple users by sharing available system resources (e.g., bandwidth and transmit power). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency-division multiple access (SC-FDMA) system, and a multi-carrier frequency division multiple access (MC-FDMA) system.

A device-to-device (hereinafter abbreviated D2D) communication corresponds to a communication scheme transmitting and receiving audio, data and the like between UEs without passing through an evolved Node B (hereinafter abbreviated eNB) by configuring a direct link between the UEs. The D2D communication can include such a communication scheme as a UE-to-UE communication scheme, a peer-to-peer communication scheme and the like. The D2D communication scheme can be applied to a M2M (machine-to-machine) communication, MTC (machine type communication) and the like.

The D2D communication is considered as a method of solving a burden of an eNB resulted from increasing data traffic. For instance, unlike a legacy wireless communication system, the D2D communication transmits and receives data between devices without passing through an eNB. Hence, the D2D communication can reduce network overload. Moreover, if the D2D communication is introduced, it may be able to expect reduced procedures of an eNB, reduced power consumption of devices participating in the D2D, increased data transmission speed, increased network capacity, load distribution, and enlarged a cell coverage and the like.

### DISCLOSURE OF THE INVENTION

### Technical Task

A technical task of the present invention is to provide a concrete method of performing communication related to measurement of a D2D link and management of D2D communication.

Technical tasks obtainable from the present invention are non-limited the above-mentioned technical task. And, other unmentioned technical tasks can be clearly understood from the following description by those having ordinary skill in the technical field to which the present invention pertains.

### Technical Solution

To achieve these and other advantages and in accordance with the purpose of the present invention, as embodied and broadly described, according to a first technical aspect of the present invention, a method of performing D2D (device-to-device) communication, which is performed by a first device in a wireless communication system, includes the steps of receiving a D2D candidate list from a third device, receiving a D2D reference signal, which is transmitted by a second device, included in the D2D candidate list, performing measurement using the D2D reference signal and transmitting a result of the measurement to the third device.

To further achieve these and other advantages and in accordance with the purpose of the present invention, according to a different embodiment, according to a second technical aspect of the present invention, a first device performing D2D (device-to-device) communication in a wireless communication system includes a reception module and a processor, the processor configured to receive a D2D candidate list from a third device, the processor configured to receive a D2D reference signal, which is transmitted by a second device, included in the D2D candidate list, the processor configured to perform measurement using the D2D reference signal, the processor configured to transmit a result of the measurement to the third device.

The first and the second aspect of the present invention can include followings.

Devices included in the D2D candidate list may have a distance between serving cells equal to or less than a predetermined value or timing advance.

The distance and the timing advance may be proportion to complexity of a network.

The D2D candidate list can include device identifiers sorted by an order of a device most recently performed D2D communication with the first device.

The D2D candidate list can further include traffic information according to each of the device identifiers, application information, and information on a reference signal sequence.

The D2D reference signal may correspond to a zero-power CSI-RS (channel state information-reference signal).

Zero-power CSI-RS configuration configured to the first device can be delivered to the second device via upper layer signaling.

If the D2D reference signal corresponds to an SRS (sounding reference signal), configuration on the SRS may be able to satisfy at least one or more conditions including a condition that the SRS is not a multiple of an SRS period transmitted to a base station by the second device and a condition that the SRS has a value different from an SRS offset transmitted to the base station by the second device if the SRS corresponds to a multiple of the SRS period transmitted to the base station by the second device.

If the D2D reference signal is transmitted in a resource region of the first device allocated by the third device, the third device can transmit information on the resource region to the second device.

If the D2D reference signal is transmitted in a resource region of the first device allocated by the third device, the second device can decode downlink control information using an identifier of the first device.

If the result of the measurement is periodically reported to the first device, periodic CSI report type information configured to the first device can be delivered to the second device via upper layer signaling.

If a value of a CSI request field of DCI (downlink control information) received by the first device corresponds to 11, the result of the measurement can be transmitted in a subframe appearing after a k^{th} (k is an integer) subframe from a subframe in which the DCI is received.

The result of the measurement can be used by the third device to update the D2D candidate list.

The third device may correspond to one of a gateway and a cluster header terminal.

### Advantageous Effects

According to the present invention, efficiency of D2D communication can be enhanced and network load can be efficiently distributed.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram for a radio frame structure;

FIG. 2 is a diagram for a resource grid of a downlink slot;

FIG. 3 is a diagram for a structure of a downlink subframe;

FIG. 4 is a diagram for a structure of an uplink subframe;

FIG. 5 is a diagram for explaining a reference signal;

FIG. 6 is a diagram for explaining a D2D candidate list according to embodiment of the present invention;

FIG. 7 is a flowchart for explaining a method of performing D2D communication according to embodiment of the present invention;

FIG. 8 is a diagram for a configuration of a transceiver.

### BEST MODE

### Mode for Invention

The embodiments described below are constructed by combining elements and features of the present invention in a predetermined form. The elements or features may be considered optional unless explicitly mentioned otherwise. Each of the elements or features can be implemented without being combined with other elements. In addition, some elements and/or features may be combined to configure an embodiment of the present invention. The sequential order of the operations discussed in the embodiments of the present invention may be changed. Some elements or features of one embodiment may also be included in another embodiment, or may be replaced by corresponding elements or features of another embodiment.

Embodiments of the present invention will be described focusing on a data communication relationship between a base station and a terminal. The base station serves as a terminal node of a network over which the base station directly communicates with the terminal. Specific operations illustrated as being conducted by the base station in this specification may be conducted by an upper node of the base station, as necessary.

That is, it is obvious that various operations performed to implement communication with the terminal over a network composed of multiple network nodes including a base station can be conducted by the base station or network nodes other than the base station. The term “base station (BS)” may be replaced with terms such as “fixed station,” “Node-B,” “eNode-B (eNB),” and “access point.” The term “relay” may be replaced with such terms as “relay node (RN)” and “relay station (RS)”. The term “terminal” may also be replaced with such terms as “user equipment (UE),” “mobile station (MS),” “mobile subscriber station (MSS)” and “subscriber station (SS).”

It should be noted that specific terms used in the description below are intended to provide better understanding of the present invention, and these specific terms may be changed to other forms within the technical spirit of the present invention.

In some cases, well-known structures and devices may be omitted or block diagrams illustrating only key functions of the structures and devices may be provided, so as not to obscure the concept of the present invention. The same reference numbers will be used throughout this specification to refer to the same or like parts.

Exemplary embodiments of the present invention can be supported by standard documents for at least one of wireless access systems including an institute of electrical and electronics engineers (IEEE) 802 system, a 3rd generation partnership project (3GPP) system, a 3GPP long term evolution (LTE) system, an LTE-advanced (LTE-A) system, and a 3GPP2 system. That is, steps or parts which are not described in the embodiments of the present invention so as not to obscure the technical spirit of the present invention may be supported by the above documents. All terms used herein may be supported by the aforementioned standard documents.

The embodiments of the present invention described below can be applied to a variety of wireless access technologies such as code division multiple access (CDMA), frequency division multiple access (FDMA), time division multiple access (TDMA), orthogonal frequency division multiple access (OFDMA), and single carrier frequency division multiple access (SC-FDMA). CDMA may be embodied through radio technologies such as universal terrestrial radio access (UTRA) or CDMA2000. TDMA may be embodied through radio technologies such as global system for mobile communication (GSM)/general packet radio service (GPRS)/enhanced data rates for GSM evolution (EDGE). OFDMA may be embodied through radio technologies such as IEEE 802.11 (Wi-Fi), IEEE 802.16 (WiMAX), IEEE 802-20, and evolved UTRA (E-UTRA). UTRA is a part of the universal mobile telecommunications system (UMTS). 3rd generation partnership project (3GPP) long term evolution (LTE) is a part of evolved UMTS (E-UMTS), which uses E-UTRA. 3GPP LTE employs OFDMA for downlink and employs SC-FDMA for uplink. LTE-Advanced (LTE-A) is an evolved version of 3GPP LTE. WiMAX can be explained by IEEE 802.16e standard (WirelessMAN-OFDMA reference system) and advanced IEEE 802.16m standard (WirelessMAN-OFDMA Advanced system). For clarity, the following description focuses on 3GPP LTE and 3GPP LTE-A systems. However, the spirit of the present invention is not limited thereto.

LTE/LTE-A Subframe Structure/Channel

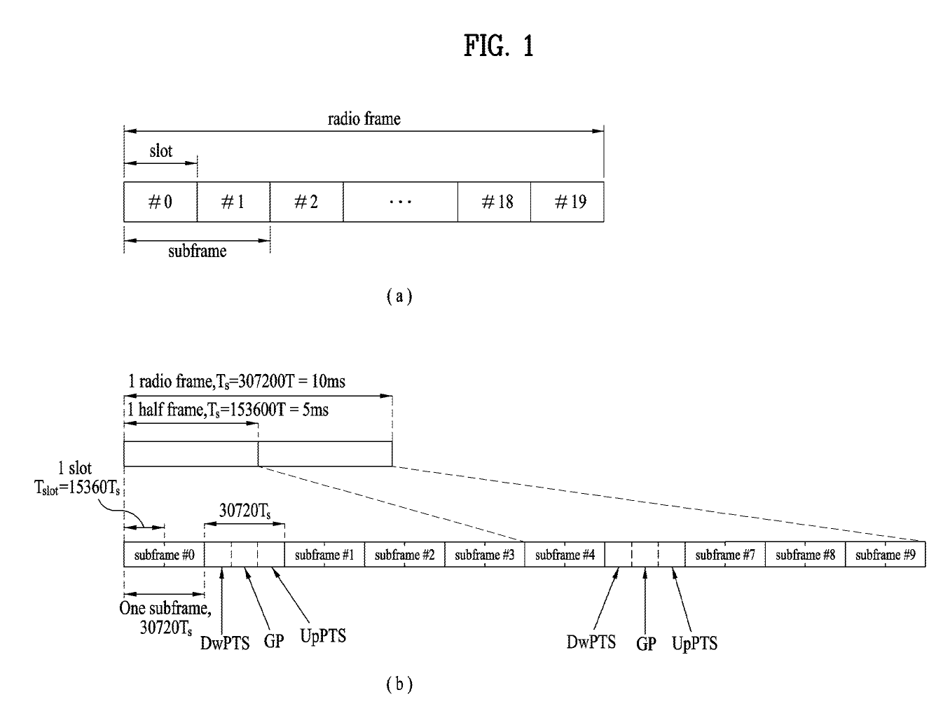

Hereinafter, a radio frame structure will be described with reference to FIG. 1.

In a cellular OFDM wireless packet communication system, an uplink (UL)/downlink (DL) data packet is transmitted on a subframe-by-subframe basis, and one subframe is defined as a predetermined time interval including a plurality of OFDM symbols. 3GPP LTE supports radio frame structure type 1 applicable to frequency division duplex (FDD) and radio frame structure type 2 applicable to time division duplex (TDD).

FIG. 1(a) illustrates radio frame structure type 1. A downlink radio frame is divided into 10 subframes. Each subframe includes two slots in the time domain. The duration of transmission of one subframe is defined as a transmission time interval (TTI). For example, a subframe may have a duration of 1 ms and one slot may have a duration of 0.5 ms. A slot may include a plurality of OFDM symbols in the time domain and a plurality of resource blocks (RBs) in the frequency domain. Since 3GPP LTE employs OFDMA for downlink, an OFDM symbol represents one symbol period. An OFDM symbol may be referred to as an SC-FDMA symbol or symbol period. A resource block (RB), which is a resource allocation unit, may include a plurality of consecutive subcarriers in a slot.

The number of OFDM symbols included in one slot depends on the configuration of a cyclic prefix (CP). CPs are divided into an extended CP and a normal CP. For a normal CP configuring each OFDM symbol, each slot may include 7 OFDM symbols. For an extended CP configuring each OFDM symbol, the duration of each OFDM symbol is extended and thus the number of OFDM symbols included in a slot is smaller than in the case of the normal CP. For the extended CP, each slot may include, for example, 6 OFDM symbols. When a channel state is unstable as in the case of high speed movement of a UE, the extended CP may be used to reduce inter-symbol interference.

When the normal CP is used, each slot includes 7 OFDM symbols, and thus each subframe includes 14 OFDM symbols. In this case, the first two or three OFDM symbols of each subframe may be allocated to a physical downlink control channel (PDCCH) and the other OFDM symbols may be allocated to a physical downlink shared channel (PDSCH).

FIG. 1(b) illustrates radio frame structure type 2. A type-2 radio frame includes two half frames, each of which has 5 subframes, downlink pilot time slots (DwPTSs), guard periods (GPs), and uplink pilot time slots (UpPTSs). Each subframe consists of two slots. The DwPTS is used for initial cell search, synchronization, or channel estimation in a UE, whereas the UpPTS is used for channel estimation in an eNB and UL transmission synchronization of a UE. The GP is provided to eliminate UL interference caused by multipath delay of a DL signal between DL and UL. Regardless of the types of radio frames, a subframe consists of two slots.

The illustrated radio frame structures are merely examples, and various modifications may be made to the number of subframes included in a radio frame, the number of slots included in a subframe, or the number of symbols included in a slot.

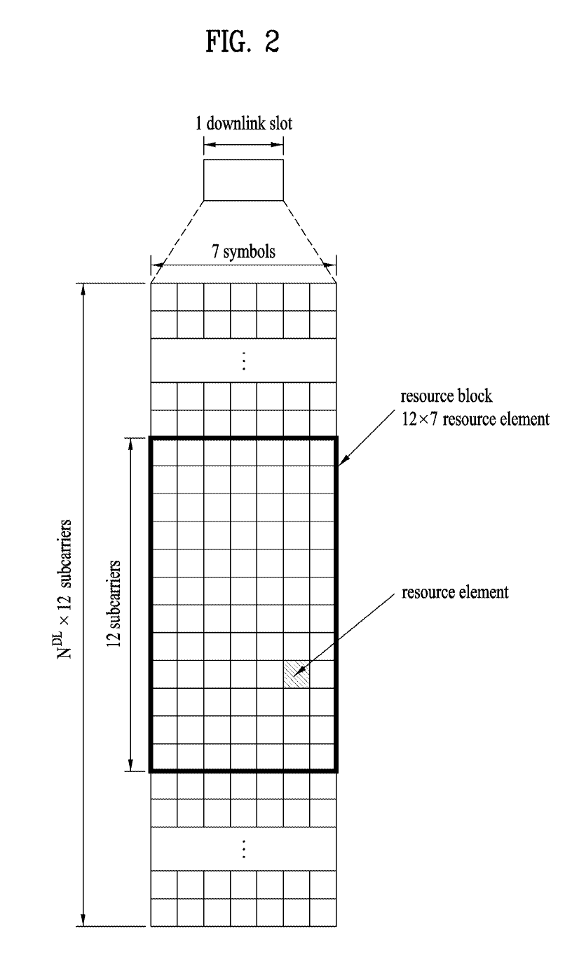

FIG. 2 is a diagram illustrating a resource grid of one DL slot. One DL slot includes 7 OFDM symbols in the time domain and an RB includes 12 subcarriers in the frequency domain. However, embodiments of the present invention are not limited thereto. For the normal CP, a slot may include 7 OFDM symbols. For the extended CP, a slot may include 6 OFDM symbols. Each element in the resource grid is referred to as a resource element (RE). An RB includes 12 7 REs. The number NDL of RBs included in a DL slot depends on a DL transmission bandwidth. A UL slot may have the same structure as the DL slot.

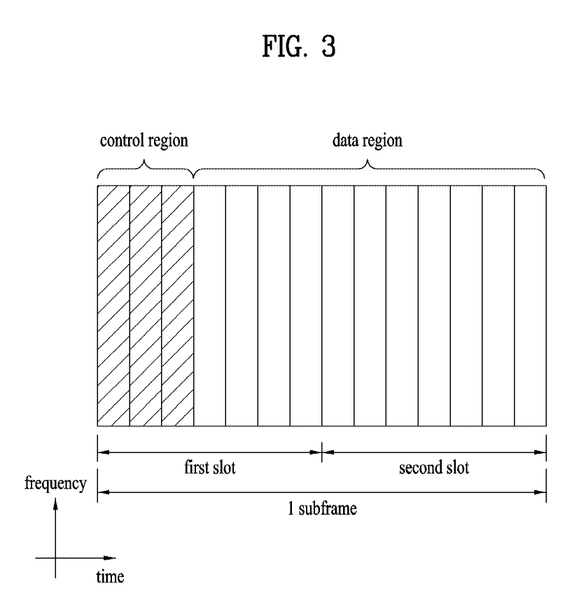

FIG. 3 illustrates a DL subframe structure. Up to three OFDM symbols in the leading part of the first slot in a DL subframe corresponds to a control region to which a control channel is allocated. The other OFDM symbols of the DL subframe correspond to a data region to which a PDSCH is allocated. DL control channels used in 3GPP LTE include, for example, a physical control format indicator channel (PCFICH), a physical downlink control channel (PDCCH), and a physical hybrid automatic repeat request (HARQ) indicator channel (PHICH). The PCFICH is transmitted in the first OFDM symbol of a subframe, carrying information about the number of OFDM symbols used for transmission of control channels in the subframe. The PHICH carries a HARQ ACK/NACK signal in response to uplink transmission. Control information carried on the PDCCH is called downlink control information (DCI). The DCI includes UL or DL scheduling information or a UL transmit power control command for a UE group. The PDCCH may deliver information about the resource allocation and transport format of a DL shared channel (DL-SCH), resource allocation information of a UL shared channel (UL-SCH), paging information of a paging channel (PCH), system information on the DL-SCH, information about resource allocation for a higher-layer control message such as a random access response transmitted on the PDSCH, a set of transmit power control commands for individual UEs in a UE group, transmit power control information, and voice over internet protocol (VoIP) activation information. A plurality of PDCCHs may be transmitted in the control region. A UE may monitor a plurality of PDCCHs. A PDCCH is transmitted in an aggregation of one or more consecutive control channel elements (CCEs). A CCE is a logical allocation unit used to provide a PDCCH at a coding rate based on the state of a radio channel. A CCE corresponds to a plurality of RE groups. The format of a PDCCH and the number of available bits for the PDCCH are determined depending on the correlation between the number of CCEs and the coding rate provided by the CCEs. An eNB determines the PDCCH format according to DCI transmitted to a UE and adds a cyclic redundancy check (CRC) to the control information. The CRC is masked with an identifier (ID) known as a radio network temporary identifier (RNTI) according to the owner or usage of the PDCCH. If the PDCCH is directed to a specific UE, its CRC may be masked with a cell-RNTI (C-RNTI) of the UE. If the PDCCH is for a paging message, the CRC of the PDCCH may be masked with a paging radio network temporary identifier (P-RNTI). If the PDCCH delivers system information (more specifically, a system information block (SIB)), the CRC may be masked with a system information ID and a system information RNTI (SI-RNTI). To indicate a random access response which is a response to a random access preamble transmitted by a UE, the CRC may be masked with a random access-RNTI (RA-RNTI).

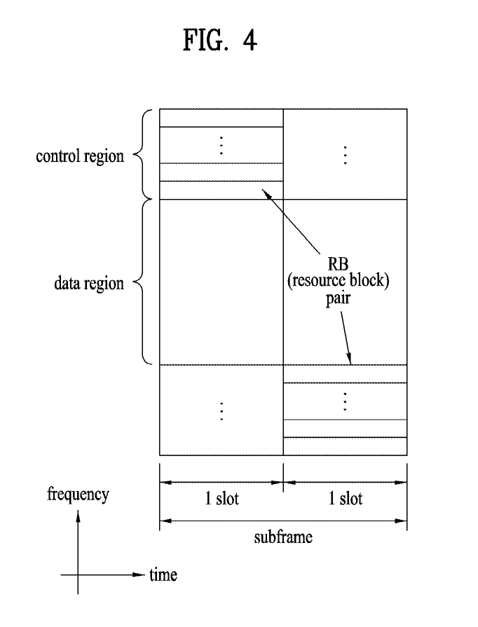

FIG. 4 illustrates a UL subframe structure. A UL subframe may be divided into a control region and a data region in the frequency domain. A physical uplink control channel (PUCCH) carrying uplink control information is allocated to the control region. A physical uplink shared channel (PUSCH) carrying user data is allocated to the data region. To maintain single carrier property, a UE does not simultaneously transmit a PUSCH and a PUCCH. A PUCCH for a UE is allocated to an RB pair in a subframe. The RBs from an RB pair occupy different subcarriers in two slots. This is called frequency hopping of the RB pair allocated to the PUCCH over a slot boundary.

Reference Signal (RS)

When a packet is transmitted in a wireless communication system, since the packet is transmitted via a radio channel, a signal may be distorted in the course of transmission. In order for a receiving end to correctly receive a distorted signal, it may be preferable that the distorted and received signal is corrected using channel information. In order to find out the channel information, a signal known to both of a transmitting end and the receiving end is transmitted and finds out the channel information with the extent of distortion when the signal is received on a channel. The signal is called a pilot signal or a reference signal.

When a data is transmitted/received using MIMO antenna, it may be preferable that a channel state between a transmitting antenna and a receiving antenna is detected in order for a receiving end to correctly receive the data. Hence, a separate reference signal should exist according to each transmitting antenna, specifically, each antenna port.

A reference signal can be classified into an uplink reference signal and a downlink reference signal. In a current LTE system, the uplink reference signal includes:

i) a DM-RS (demodulation-reference signal) for channel estimation to coherently demodulate information transmitted on PUSCH and PUCCH

ii) an SRS (sounding reference signal) used for an eNode B to measure UL channel quality on a frequency of different network.

Meanwhile, the downlink reference signal includes:

i) a cell-specific reference signal (CRS) shared by all user equipments in a cell

ii) a UE-specific reference signal used for a specific user equipment

iii) a DM-RS (demodulation-reference signal) transmitted for coherent demodulation in case of transmitting PDSCH

iv) a CSI-RS (channel state information-reference signal) used for delivering CSI (channel state information) in case of transmitting a downlink DMRS

v) an MBSFN reference signal transmitted to coherently demodulate a signal transmitted in MBSFN (multimedia broadcast single frequency network) mode

vi) a positioning reference signal used for estimating geographical location information of a user equipment.

A reference signal (RS) is mainly classified into two types in accordance with a purpose of the RS. One type of the RS is used to obtain channel information and another type of the RS is used to demodulate data. Since the former one is the RS to make a UE obtain DL channel information, it is transmitted in wideband. Although a UE does not receive DL data in a specific subframe, the UE should receive and measure the corresponding RS. This sort of RS can also be used for performing a measurement for a handover and the like. In case that a base station transmits a resource in DL, the latter one corresponds to an RS transmitted together with the resource. A UE can perform channel estimation by receiving the RS and may be then able to demodulate data. This sort of RS should be transmitted to a region to which the data is transmitted.

A CRS is used for two purposes including channel information acquisition and data demodulation. On the contrary, a UE-specific reference signal is used for a purpose of data demodulation only. The CRS is transmitted in every subframe for a wideband. The CRS for maximum 4 antenna ports can be transmitted according to the number of transmitting antennas of a base station.

For instance, if the number of antenna ports of the base station corresponds to 2, a CRS for 0^{th} antenna port and a CRS for 1^{st} antenna port are transmitted. If the number of antenna ports of the base station corresponds to 4, CRSs for 0 to 3^{rd} antenna port are transmitted, respectively.

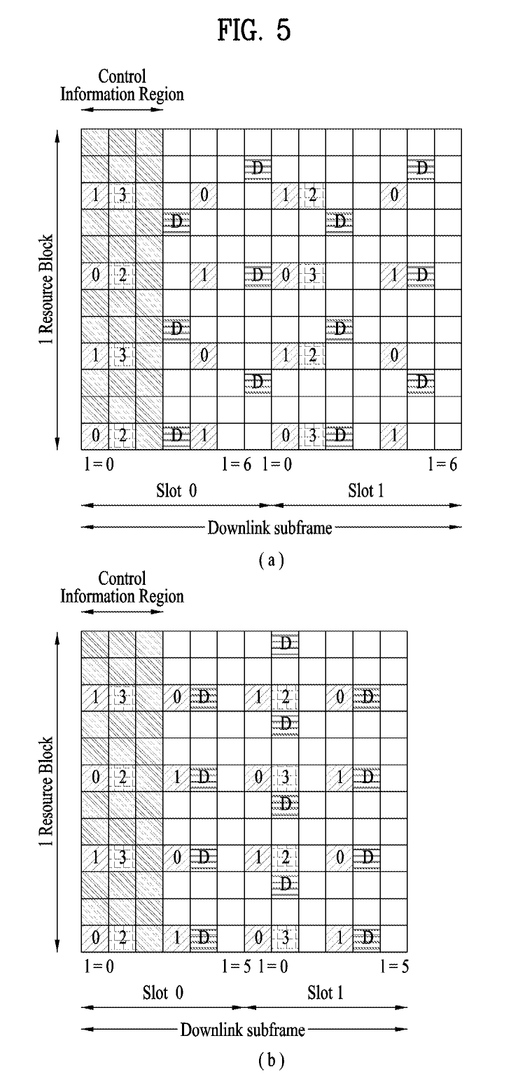

FIG. 5 is a diagram for patterns that a CRS and a DRS defined by a legacy 3GPP LTE system (e.g., release-9) are mapped to a downlink resource block (RB) pair. The downlink RB pair as a reference signal mapping unit can be represented by a unit of ‘one subframe in time domain×12 subcarriers on frequency domain’ In particular, one RB pair has a length of 14 OFDM symbols in case of a normal CP (FIG. 5(a)) and a length of 12 OFDM symbols in case of an extended CP (FIG. 5(b)) in time domain.

FIG. 5 shows a position of a reference signal on RB pairs in a system where a base station supports 4 transmission antennas. In FIG. 5, resource elements (RE) represented as ‘0’, ‘1’, ‘2’, and ‘3’ indicate a position of the CRS for an antenna port 0, 1, 2, and 3, respectively. Meanwhile, a resource element represented as ‘D’ in FIG. 5 indicates a position of a DM-RS.

Measurement/Measurement Report

A measurement report is used for one or more methods for securing mobility of a terminal. Since coherent demodulation in some degree is required for the measurement report, the measurement report can be performed after a terminal obtains synchronization and physical layer parameters except measurement of reception signal strength. The measurement report corresponds to a concept including RSRP (reference signal receive power) for measuring signal strength of a serving cell or a neighbor cell or signal strength compared to total reception power, RRM measurement for measuring RSSI (received signal strength indicator), RSRQ (reference signal received quality) and the like and RLM measurement for measuring link quality with a serving cell and evaluating whether a radio link is failed.

In relation to the RRM, the RSRP corresponds to a linear average of power distribution of an RE in which a CRS is transmitted in downlink. The RSSI corresponds to a linear average of total reception power received by a corresponding terminal. An OFDM symbol including an RS for an antenna port 0 is a target of the RSSI measurement. The RSSI corresponds to a measurement value including interference and noise power from neighboring cells. If higher layer signaling indicates a specific subframe to measure the RSRQ, the RSSI is measured for all OFDM symbols included in the indicated specific subframe. The RSRQ corresponds to a value measured in a form of N*RSRP/RSSI. In this case, N corresponds to the number of RBs of a corresponding bandwidth when the RSSI is measured.

The RLM is performed to enable a terminal to monitor downlink quality of a serving cell of the terminal and determine ‘in-sync’ or ‘out-of-sync’ for the corresponding cell. In this case, the RLM is performed based on a CRS. The downlink quality estimated by the terminal is compared with ‘in-synch threshold (Qin)’ and ‘out-of-synch threshold (Qout)’. These threshold values can be represented by PDCCH BLER (block error rate) of a serving cell. In particular, the Qout and the Qin correspond to 10% BLER and 2% BLER, respectively. Practically, the Qin and the Qout are values corresponding to SINR of a received CRS. If the CRS reception SINR is greater than a certain level (Qin), a terminal determines to be attached to a corresponding cell. On the contrary, if the reception SINR is less than the certain level (Qout), the terminal declares RLF (radio link failure).

As mentioned earlier in the definition of the RSRP and the like, the basic premise is that a measurement report is performed using a CRS. Yet, if cells share an identical PCID with each other, since it is difficult to distinguish the cells including the identical PCID from the CRS, if a measurement report including RSRP/RSRQ is performed based on the CRS only, RRM for each cell is unable to be performed. Hence, if cells include an identical PCID, it is able to make an additional RSRP/RSRQ measurement report to be performed based on individually transmitted CSI-RS. When a CSI-RS of a specific cell is received, in order to increase reception accuracy, neighboring cells do not transmit signal to an RE in which the CSI-RS is transmitted. By doing so, although transmission frequency of the CSI-RS is lower than transmission frequency of a CRS, more precise measurement can be performed. Hence, even when cells include PCID different from each other, if CRS-based RSRP/RSRQ measurement report and CSI-RS RSRP/RSRQ measurement report are performed together, accuracy of RRM of a network can be enhanced.

Another main purpose of transmitting a CSI-RS in each cell is to perform CSI feedback performed by a terminal to help scheduling of a base station, which determines a rank, a precoding matrix, MCS (modulation and coding scheme or CQI) and the like to be used for transmitting downlink data between a corresponding cell and the terminal. In case of CoMP transmission scheme, a terminal should feedback CSI not only for a downlink with a serving cell but also for a downlink with a cooperative cell. If CSI feedback is performed for all cells in a CoMP cluster to which the serving cell of the terminal belongs thereto, overhead becomes too big. Hence, it is able to configure the CSI feedback to be performed for a part of cells only belonging to the CoMP cluster, i.e., a CoMP measurement set where cooperative scheduling and cooperative data transmission are valuable to be performed. Determination on a CoMP measurement set for a specific terminal can be configured in a manner of selecting cells of which RSRP is greater than a certain level. To this end, a terminal performs RSRP measurement report for cells in a CoMP cluster to which the terminal belongs thereto. Or, a base station informs the terminal of configurations of CSI-RSs on which RSRP or RSRQ measurement to be performed by the terminal in a manner of designating the configurations of the CSI-RSs as a CoMP management set and the terminal performs the RSRP or the RSRQ measurement on the CSI-RSs transmitted from cells belonging to the designated CoMP management set. If a result of the measurement satisfies a specific condition, the terminal can perform a report.

Moreover, in order to make ICIC to be performed between CoMP clusters, a terminal performs RSRP measurement and a report on cells belonging to a neighboring CoMP cluster to identify a cell giving strong interference to the terminal among the cells belonging to the neighboring CoMP cluster and a cell receiving strong uplink interference from the terminal.

Together with a CRS-based RSRP/RSRQ measurement report for mobility management of a terminal such as handover and the like, a CSI-RS-based RSRP/RSRQ measurement report is performed for CoMP measurement set configuration and ICIC. By doing so, RRM accuracy of a network and flexibility can be enhanced.

Meanwhile, network triggered D2D communication can be performed. Specifically, for instance, i) if a network knows a position of a terminal or a geographical positon between terminals is close to each other, ii) if there exist information to be directly transceived between terminals, iii) if it is necessary to offload traffic by D2D due to big network load, a network can trigger direct communication between the terminals. In this case, it may be able to perform data communication of high efficiency reducing the network load and utilizing a benefit of a short distance between the terminals.

Hence, in the following, a method for a network to efficiently manage D2D, operation and configuration of D2D devices according to the method and the like are explained based on the aforementioned descriptions. The method of managing the D2D, operation of D2D devices and the like described in the following are continuously recognized by a network to efficiently manage a radio resource and measurement/measurement report on a D2D link is periodically/aperiodically performed to increase efficiency of radio resource management. In the following description, a first device and a second device may correspond to a device capable of performing D2D communication and a third device may indicate a network node such as a gateway and the like, a cluster header terminal device or a master terminal device. And, the first device can also be called a dRUE in the aspect of receiving a reference signal for D2D and the second device can also be called a dTUE in the aspect of transmitting a reference signal for D2D.

Setup of D2D Candidate List

The third device can identify that devices or a group of devices are located at an identical network in a manner of monitoring/detecting IP traffic between devices belonging to the network. And, the third device considers the IP traffic/device satisfying a specific condition as potential D2D traffic and may be able to set a D2D candidate list. In this case, the specific condition may correspond to a distance equal to or less than a predetermined value or timing advance (value) of the devices. For instance, if a geographical distance difference between serving cells providing a service to the devices is within a specific threshold, if a geographical distance difference between devices belonging to an identical serving cell is within a specific threshold, or if a timing advance value of the devices belonging to an identical serving cell is within a specific threshold, the devices can be included in the D2D candidate list. In this case, the distance and the timing advance may be proportional to complexity of a network. In other word, the aforementioned threshold value may vary according to traffic load of the network. For instance, if traffic of the network is excessive, devices located at a relatively long distance can be included in the D2D candidate list for traffic offloading. In this case, if a geographic distance between two devices is within a specific threshold, it may indicate not only a physical distance difference but also strength of a reception (reference) signal, pathloss value, or an RSRP value less than a prescribed range.

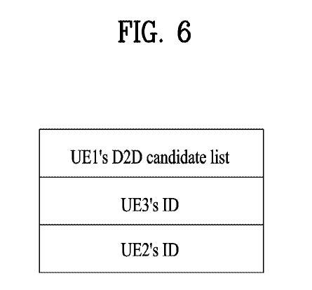

The D2D candidate list can include an ID (e.g., C-RNTI) of a device, traffic information, application information, information on a reference signal sequence and the like. Devices most recently transceived traffic or devices most recently requested D2D can be positioned at the top of the D2D candidate list. In other word, the D2D candidate list can include device IDs sorted by an order of devices most recently performed D2D communication. For instance, referring to FIG. 6, if a first device (UE 1) performs communication with a second device (UE 2) belonging to a serving cell, which is located at a distance within a specific threshold from a serving cell of the first device (or, if distance/timing advance between the first device and the second device is equal to or less than a threshold), and the first device performs communication with a different fourth device (UE 3), the fourth device (ID) can be positioned at the top of the second device in the D2D candidate list. The aforementioned D2D candidate list may exist according to each device. A network manages the D2D candidate list and may be able to deliver the D2D candidate list to a device if necessary.

The D2D candidate list can be modified by a direct request of a device. Or, the D2D candidate list can be modified based on a measurement report, which is described later, of a device. And, if a device requests to perform D2D communication with a different device located within a short distance by a specific application, the device reports an ID of the different device with which the D2D communication is to be performed to a network. By doing so, the D2D candidate list can be modified.

In the foregoing description, if a D2D device operates at the outside of coverage, as mentioned in the foregoing description, the third device may correspond to a master terminal device or a cluster header device. In this case, the master terminal device or the cluster header device may be able to perform such an operation as radio resource scheduling for D2D and the like. And, if a D2D device operates at the outside of coverage, the D2D candidate list can be directly managed by each device. In this case, each device places an ID of a device most recently performed D2D communication at the top of the D2D candidate list and may be then able to preferentially monitor and/or discover the ID. In case of group communication, a group member can be included in the D2D candidate list.

A part of the D2D candidate list or the entire D2D candidate list can be signaled to each device related to D2D communication. As an example of transmitting a part of the D2D candidate list, the upper most (the most recent) n (n is a natural number) number of device IDs of the D2D candidate list can be transmitted via upper layer signaling or L1/L2 signaling. If the D2D candidate list is signaled to a device, the device is able to aware of a device ID. Hence, if D2D communication is triggered or D2D link measurement report is requested by a base station, the device may be able to reduce signaling necessary for obtaining a device ID. In other word, information on a device ID transmitted by signaling of the D2D candidate list can be used for discovery associated with D2D communication, D2D link measurement and/or measurement report.

Measurement of D2D Link Quality

Measurement of D2D link quality can be performed using a D2D reference signal transmitted by a D2D device. In this process, information (e.g., a device ID and the like) obtained by the aforementioned D2D candidate list can be used. For instance, a first device receiving a D2D reference signal is able to know an ID of a second device transmitting the D2D reference signal via the D2D candidate list. In this case, a sequence ID of a reference signal of the first device or PDCCH/EPDCCH can be decoded using the ID of the second device.

A reference signal transmitted by a D2D device may reuse a reference signal defined by a legacy LTE/LTE-A system or a legacy reference signal sequence can be transmitted in a resource region newly defined for D2D. In the following, each D2D reference signal proposed by the present invention and D2D link quality measurement according to the D2D reference signal are described.

First of all, a downlink reference signal (i.e., a CSI-RS) can be used as a D2D reference signal. Since a CSI-RS corresponds to a downlink reference signal, in order to use the CSI-RS as a D2D reference signal, it is necessary for a second device to be a device capable of transmitting in a downlink resource. A zero-power CSI-RS can be used as a D2D reference signal. In particular, a third device can configure the zero-power CSI-RS to a first device (In this case, it is necessary to perform rate matching on a region to which the zero-power CSI-RS is transmitted among a PDSCH region of the first device). Configuration information on the zero-power CSI-RS configured to the first device can be delivered to a second device via upper layer signaling and the like. Reference signal transmit power of the second device can be determined based on a value indicated (or, signaled) by a base station and the value can be signaled to the first device as well. In case of indicating the transmit power, a value of the transmit power can be directly indicated or a difference value with uplink transmit power (uplink transmit power of PUSCH, PUCCH, SRS, etc.) can be signaled.

Secondly, an uplink reference signal can be used as a D2D reference signal. As a representative example, an SRS can be used as a D2D reference signal. In this case, the SRS can be configured in a manner of satisfying one of conditions including that the SRS is not a multiple of an SRS period transmitted to a base station by the second device, if the SRS is a multiple of the SRS period transmitted to the base station by the second device, the SRS has a value different from an SRS offset transmitted to the base station by the second device. For instance, if an SRS of the second device is configured by a configuration 1 of Table 1, it is necessary to use configuration 3 to 8 of which a period is not a multiple of 2 for D2D. This is because, if an SRS, which has a considerable difference in transmit power, is transmitted in an identical SF in a manner of being multiplexed, it is highly probable that a D2D-SRS of low transmit power is not detected. In the same manner, if the SRS of the second device is configured by a configuration 2, among a configuration 2 and configuration 9 to 14 of which a period is a multiple of 2, the configuration 2, 10, 11 and 12 of which an offset is different from an offset 0 of the configuration 1 can be used for the use of a D2D SRS.

TABLE 1

| | | Configuration | Transmission |
|---|---|---|---|
| | | Period T_{SFC} | offset Δ_{SFC} |
| srs-SubframeConfig | Binary | (subframes) | (subframes) |
| 0 | 0000 | 1 | {0} |
| 1 | 0001 | 2 | {0} |
| 2 | 0010 | 2 | {1} |
| 3 | 0011 | 5 | {0} |
| 4 | 0100 | 5 | {1} |
| 5 | 0101 | 5 | {2} |
| 6 | 0110 | 5 | {3} |
| 7 | 0111 | 5 | {0, 1} |
| 8 | 1000 | 5 | {2, 3} |
| 9 | 1001 | 10 | {0} |
| 10 | 1010 | 10 | {1} |
| 11 | 1011 | 10 | {2} |
| 12 | 1100 | 10 | {3} |
| 13 | 1101 | 10 | {0, 1, 2, 3, 4, 6, 8} |
| 14 | 1110 | 10 | {0, 1, 2, 3, 4, 5, 6, 8} |
| 15 | 1111 | reserved | reserved |

If the second device transmits a D2D reference signal using a specific SRS configuration, in order to properly receive the D2D reference signal, it is necessary to transmit related information to the first device as well. In order to transmit the related information to the first device, it may be able to use upper layer signaling and the like. If D2D reference signal transmission is triggered to the second device, D2D reference signal reception should be triggered to the first device as well. To this end, a partial field of a DCI format can be designated by RRC. For instance, a specific state of an SRS request field can be used for the use of triggering a D2D-SRS reception mode to receive an SRS, which is transmitted as a D2D reference signal. Or, one state of a CIF field of a DCI format can be used for the use of triggering the D2D-SRS reception mode.

Thirdly, a previously defined sequence can be transmitted in a resource region newly defined for a D2D reference signal. For instance, uplink reference signal sequence (RACH (random access channel) preamble, an SRS sequence, etc.) can be transmitted via an uplink resource region (PUSCH) or a downlink resource region (PDSCH). In other word, the second device can transmit a sequence corresponding to an uplink reference signal to a PDSCH region of the first device. To this end, the third device can deliver resource allocation information allocated to the first device to the second device (via upper layer signaling). Or, the second device decodes PDCCH using an ID of the first device obtained via the D2D candidate list and may be then able to obtain the resource allocation information allocated to the first device. A D2D reference signal can be transmitted to a partial subframe among subframes to which PDSCH of the first device is transmitted. In this case, a period and/or an offset of the subframes in which the D2D reference signal is transmitted can be delivered to the second device via upper layer signaling. Or, it may be able to promise in advance that a D2D reference signal is transmitted in a subframe satisfying a specific rule only among the subframes in which the PDSCH of the first device is transmitted. As a concrete example, it may be able to promise in advance that a D2D reference signal is transmitted in a subframe including a number of multiple of 5 among the subframes in which the PDSCH of the first device is transmitted. Or, the first and the second device operate a timer and it may be able to promise that a D2D reference signal is transmitted with a prescribed period while the timer is operating. A position to which a D2D reference is actually transmitted among PDSCH region can be determined in advance. For instance, a reference signal sequence can be transmitted in a manner of sequentially mapping the reference signal sequence to REs from the foremost RE of an OFDM symbol in an order of ‘frequency first’. In this case, rate matching should be performed on the PDSCH region of the first device and a base station can deliver information on the rate matching to the first device via upper layer signaling.

As a different example, sequence of an uplink signal (RACH, DMRS, SRS, etc.) can be transmitted in a PUSCH region as a D2D reference signal. In this case, it is necessary for the first device to recognize a PUSCH region of the second device. To this end, the PUSCH region of the second device is delivered to the first device via upper layer signaling. Or, the first device is able to know the PUSCH region of the second device in a manner of decoding DCI using an ID of the second device. A D2D reference signal can be transmitted in a partial subframe only among subframes in which the PUSCH of the second device is transmitted. In this case, a period and/or an offset of the subframes in which the D2D reference signal is transmitted can be delivered to the first device via upper layer signaling. Or, it may be able to promise in advance that a D2D reference signal is transmitted in a subframe satisfying a specific rule only among the subframes in which the PDSCH of the second device is transmitted. As a concrete example, it may be able to promise in advance that a D2D reference signal is transmitted in a subframe including a number of multiple of 5 among the subframes in which the PDSCH of the first device is transmitted. Or, the first and the second device operate a timer and it may be able to promise that a D2D reference signal is transmitted with a prescribed period while the timer is operating. A position to which a D2D reference is actually transmitted among PDSCH region can be determined in advance. For instance, a reference signal sequence can be transmitted in a manner of sequentially mapping the reference signal sequence to REs from the foremost RE of an OFDM symbol in an order of ‘frequency first’. In this case, rate matching should be performed on the PDSCH region of the second device and a base station can deliver information on the rate matching to the first device via upper layer signaling.

D2D Measurement Report

As mentioned in the foregoing description, having received a D2D reference signal, a first device performs measurement using the D2D reference signal and may be able to report a result of the measurement to a third device. The measurement result can be periodically transmitted via PUCCH or can be aperiodically transmitted via PUSCH.

If the measurement result is periodically transmitted to the first device, information on a periodic CSI report type configured to the first device can be delivered to the second device via upper layer signaling. In this case, the information delivered to the second device can include a CSI report interval, a CSI report subframe offset and the like. The second device can transmit a D2D reference signal in a downlink resource in accordance with the periodic CSI report type of the first device.

Aperiodic measurement result report can be triggered by uplink DCI. For instance, if a CSI request field value of a DCI format 0 and 4 are set to 11, it triggers a D2D measurement result. Hence, the first device can transmit a measurement report in a subframe appearing after a k^{th} subframe from a subframe in which DCI is received. In this case, the value of the CSI request field and meaning of the value are shown in Table 2 in the following.

TABLE 2

| Value of CSI request field | Description |
|---|---|
| ‘00’ | No aperiodic CSI report is triggered |
| ‘01’ | Aperiodic CSI report is triggered for a |
| | set of CSI process(es) configured by |
| | higher layers for serving cell c |
| ‘10’ | Aperiodic CSI report is triggered for a 1st |
| | set of CSI process(es) configured by |
| | higher layers |
| ‘11’ | Aperiodic CSI report is triggered for a D2D |
| | measurement CSI process(es) configured by |
| | higher layers |

A second device can transmit a D2D reference signal to a position of a zero-power CSI-RS and this triggering can be indicated by a specific field of a DCI format. A value and a field used for triggering the transmission of the D2D reference signal can be indicated by upper layer signaling. A subframe in which DCI triggering transmission of the D2D reference signal of the second device is transmitted should be ahead of a subframe in which DCI triggering a reference signal measurement result of the first device is transmitted.

In summary, the aforementioned D2D link quality measurement is to receive indication of an ID list of a device from a base station and to measure a reference signal transmitted from the device (using an ID of the device). The D2D link quality measurement can be non-continuously performed in case that there exist triggering from a base station and the like. And, due to a characteristic of D2D communication (i.e., it is highly probable that D2D communication is performed in a short range), there may exist a separate CQI table irrespective of a CQI table for cellular.

Update of D2D Candidate List

A measurement result of a D2D link obtained from a first device can be used for updating a D2D candidate list in a third device. For instance, the D2D candidate list can be updated to make a D2D device of good quality to be positioned at the top of the list. Or, a D2D device can be positioned at the top of the list in a manner of giving priority to a device, which has received a D2D communication request. The updated D2D candidate list can be delivered to the D2D device again via upper layer signaling and the like. If the measurement result is less than a predetermined standard, a base station can indicate the first device and/or the second device to increase transmit power of a D2D reference signal little bit. This sort of transmit power control (TPC) command can be transmitted via a higher layer signal, DCI or the like. If the DCI is used for the TPC command, it may be able to use a TPC field, a specific state of a CFI field, and the like.

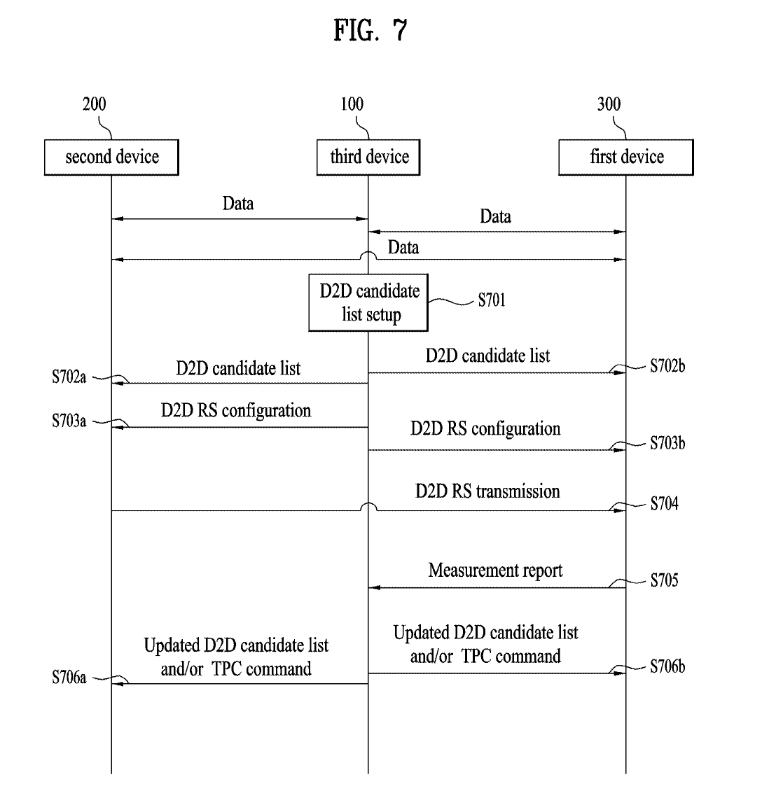

FIG. 7 shows an example of operations of devices related to D2D based on the aforementioned D2D communication management method. For clarity, FIG. 7 is explained on the basis of a first device configured to perform D2D communication and receive a D2D reference signal. If content is not specifically mentioned in explanation on each step in the following description, it is apparent that the content can be replaced or referred with/to each part of the aforementioned D2D candidate list setup, D2D link quality measurement, D2D measurement report, and D2D candidate list update. And, it is not mandatory to perform each of the steps described in FIG. 7 as a whole. If necessary, one or more specific steps can be omitted. Although it is depicted as each signal is preferentially transmitted to a first device and is transmitted to a second signal later in the steps of S702a, S702b, S706a and S706b, a signal can be transmitted to the first device and the second device at the same time. Or, a signal can be preferentially transmitted to the second device and can be transmitted to the first device later.

Referring to FIG. 7, a third device can setup a D2D candidate list in a manner of monitoring data transmission and reception between the first device and the second device [S701]. The first device can receive the D2D candidate list from the third device [S702b]. Subsequently, the first device can receive a D2D reference signal, which is transmitted from the second device included in the D2D candidate list [S704]. To this end, the first device may receive D2D reference signal configuration information from the third device [S703b]. As mentioned in the foregoing description, the D2D reference signal may correspond to a reference signal of a form that a CSI-RS, an SRS or a sequence defined in LTE system is transmitted in a resource region configured for D2D. Having received the D2D reference signal, the first device performs measurement and may be able to report a result of the measurement to the third device [S705]. The measurement result report can be used for updating the D2D candidate list and performing a transmit power control command in the third device. In this case, the first device can receive an updated D2D candidate list and the like from the third device.

Configurations of Devices for Embodiments of the Present Invention

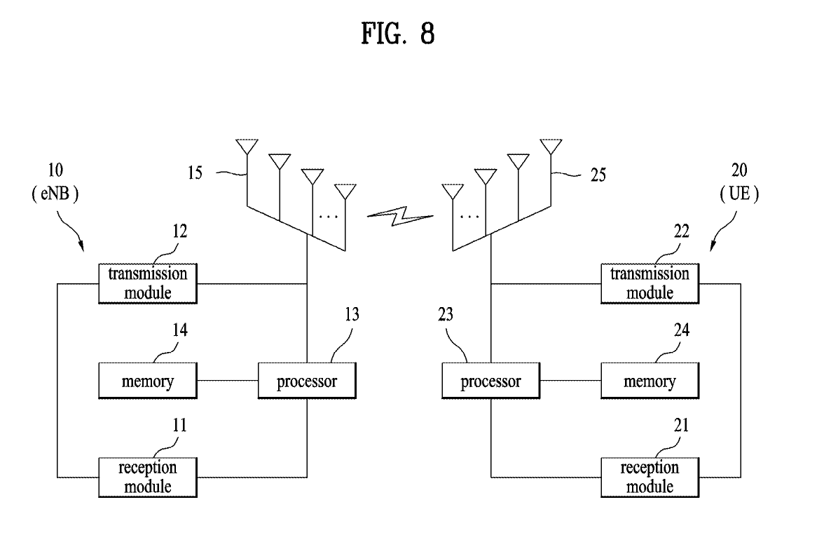

FIG. 8 is a diagram illustrating configuration of a transmit point apparatus and a UE according to one embodiment of the present invention.

Referring to FIG. 8, a transmit point apparatus 10 may include a receive module 11, a transmit module 12, a processor 13, a memory 14, and a plurality of antennas 15. The antennas 15 represent the transmit point apparatus that supports MIMO transmission and reception. The receive module 11 may receive various signals, data and information from a UE on an uplink. The transmit module 12 may transmit various signals, data and information to a UE on a downlink. The processor 13 may control overall operation of the transmit point apparatus 10.

The processor 13 of the transmit point apparatus 10 according to one embodiment of the present invention may perform processes necessary for the embodiments described above.

Additionally, the processor 13 of the transmit point apparatus 10 may function to operationally process information received by the transmit point apparatus 10 or information to be transmitted from the transmit point apparatus 10, and the memory 14, which may be replaced with an element such as a buffer (not shown), may store the processed information for a predetermined time.

Referring to FIG. 8, a UE 20 may include a receive module 21, a transmit module 22, a processor 23, a memory 24, and a plurality of antennas 25. The antennas 25 represent the UE that supports MIMO transmission and reception. The receive module 21 may receive various signals, data and information from an eNB on a downlink. The transmit module 22 may transmit various signals, data and information to an eNB on an uplink. The processor 23 may control overall operation of the UE 20.

The processor 23 of the UE 20 according to one embodiment of the present invention may perform processes necessary for the embodiments described above.

Additionally, the processor 23 of the UE 20 may function to operationally process information received by the UE 20 or information to be transmitted from the UE 20, and the memory 24, which may be replaced with an element such as a buffer (not shown), may store the processed information for a predetermined time.

The configurations of the transmit point apparatus and the UE as described above may be implemented such that the above-described embodiments can be independently applied or two or more thereof can be simultaneously applied, and description of redundant parts is omitted for clarity.

Description of the transmit point apparatus 10 in FIG. 8 may be equally applied to a relay as a downlink transmitter or an uplink receiver, and description of the UE 20 may be equally applied to a relay as a downlink receiver or an uplink transmitter.

The embodiments of the present invention may be implemented through various means, for example, hardware, firmware, software, or a combination thereof.

When implemented as hardware, a method according to embodiments of the present invention may be embodied as one or more application specific integrated circuits (ASICs), one or more digital signal processors (DSPs), one or more digital signal processing devices (DSPDs), one or more programmable logic devices (PLDs), one or more field programmable gate arrays (FPGAs), a processor, a controller, a microcontroller, a microprocessor, etc.

When implemented as firmware or software, a method according to embodiments of the present invention may be embodied as a module, a procedure, or a function that performs the functions or operations described above. Software code may be stored in a memory unit and executed by a processor. The memory unit is located at the interior or exterior of the processor and may transmit and receive data to and from the processor via various known means.

Preferred embodiments of the present invention have been described in detail above to allow those skilled in the art to implement and practice the present invention. Although the preferred embodiments of the present invention have been described above, those skilled in the art will appreciate that various modifications and variations can be made in the present invention without departing from the spirit or scope of the invention. For example, those skilled in the art may use a combination of elements set forth in the above-described embodiments. Thus, the present invention is not intended to be limited to the embodiments described herein, but is intended to accord with the widest scope corresponding to the principles and novel features disclosed herein.

The present invention may be carried out in other specific ways than those set forth herein without departing from the spirit and essential characteristics of the present invention. Therefore, the above embodiments should be construed in all aspects as illustrative and not restrictive. The scope of the invention should be determined by the appended claims and their legal equivalents, and all changes coming within the meaning and equivalency range of the appended claims are intended to be embraced therein. The present invention is not intended to be limited to the embodiments described herein, but is intended to accord with the widest scope consistent with the principles and novel features disclosed herein. In addition, claims that are not explicitly cited in each other in the appended claims may be presented in combination as an embodiment of the present invention or included as a new claim by subsequent amendment after the application is filed.

### INDUSTRIAL APPLICABILITY

Embodiments of the present invention are applicable to various mobile communication systems.

What is claimed is:

1. A method of performing D2D (device-to-device) communication, which is performed by a first device in a wireless communication system, comprising the steps of:
receiving a D2D candidate list from a third device;
receiving a D2D reference signal, which is transmitted by a second device, contained in the D2D candidate list;
performing measurement using the D2D reference signal; and
transmitting a result of the measurement to the third device.

2. The method of claim 1, wherein devices contained in the D2D candidate list have a distance between serving cells equal to or less than a predetermined value or timing advance.

3. The method of claim 1, wherein the distance and the timing advance are proportion to complexity of a network.

4. The method of claim 1, wherein the D2D candidate list comprises device identifiers sorted by an order of a device most recently performed D2D communication with the first device.

5. The method of claim 4, wherein the D2D candidate list further comprises traffic information according to each of the device identifiers, application information, and information on a reference signal sequence.

6. The method of claim 1, wherein the D2D reference signal corresponds to a zero-power CSI-RS (channel state information-reference signal).

7. The method of claim 6, wherein zero-power CSI-RS configuration configured to the first device is delivered to the second device via upper layer signaling.

8. The method of claim 1, wherein if the D2D reference signal corresponds to an SRS (sounding reference signal), configuration on the SRS satisfies at least one or more conditions containing a condition that the SRS is not a multiple of an SRS period transmitted to a base station by the second device and a condition that the SRS has a value different from an SRS offset transmitted to the base station by the second device if the SRS corresponds to a multiple of the SRS period transmitted to the base station by the second device.

9. The method of claim 1, wherein if the D2D reference signal is transmitted in a resource region of the first device allocated by the third device, the third device transmits information on the resource region to the second device.

10. The method of claim 1, wherein if the D2D reference signal is transmitted in a resource region of the first device allocated by the third device, the second device decodes downlink control information using an identifier of the first device.

11. The method of claim 1, wherein if the result of the measurement is periodically reported to the first device, periodic CSI report type information configured to the first device is delivered to the second device via upper layer signaling.

12. The method of claim 1, wherein if a value of a CSI request field of DCI (downlink control information) received by the first device corresponds to 11, the result of the measurement is transmitted in a subframe appearing after a k^{th} (k is an integer) subframe from a subframe in which the DCI is received.

13. The method of claim 1, wherein the result of the measurement is used by the third device to update the D2D candidate list.

14. The method of claim 1, wherein the third device corresponds to one of a gateway and a cluster header terminal.

15. A first device performing D2D (device-to-device) communication in a wireless communication system, comprising:
a reception module; and
a processor, the processor configured to receive a D2D candidate list from a third device, the processor configured to receive a D2D reference signal, which is transmitted by a second device, contained in the D2D candidate list, the processor configured to perform measurement using the D2D reference signal, the processor configured to transmit a result of the measurement to the third device.
